(19) United States
(12) Patent Application Publication
(10) Pub. No.: US 2016/0034426 A1
(43) Pub. Date: Feb. 4, 2016

(54) Creating Cohesive Documents From Social Media Messages

(71) Applicant: Raytheon BBN Technologies Corp., Cambridge, MA (US)

(72) Inventors: Saurabh Khanwalkar, Waltham, MA (US); Anoop Kumar, Somerville, MA (US); Guruprasad Saikumar, Waltham, MA (US); Sean Colbath, Winchester, MA (US); Elio Querze, Arlington, MA (US); Amit Srivastava, Acton, MA (US)

(73) Assignee: RAYTHEON BBN TECHNOLOGIES CORP., Cambridge, MA (US)

(21) Appl. No.: 14/813,767

(22) Filed: Jul. 30, 2015

Related U.S. Application Data
(60) Provisional application No. 62/032,189, filed on Aug. 1, 2014.

(51) Int. Cl. G06F 17/21; G06F 17/24; H04L 12/58

(52) U.S. Cl. CPC G06F 17/211; H04L 51/32; G06F 17/24

(57) ABSTRACT

A technique to construct a cohesive document is described including accessing a communication system having a plurality of social media message units accessible; collecting a plurality of related social media message units among users over a predetermined period of time; outputting to a single file the plurality of related social media message units when the file reaches a predetermined size to construct a cohesive document; and outputting to a single file a plurality of related social media message units after a maximum predetermined period of time to construct a different cohesive document.

### CROSS REFERENCE TO RELATED APPLICATIONS

This application claims the benefit under 35 U.S.C. §0119(e) of U.S. Provisional Application No. 62/032,189 filed Aug. 1, 2014, which application is incorporated herein by reference in its entirety.

### STATEMENTS REGARDING FEDERALLY SPONSORED RESEARCH

This invention was made with Government support under Contract No. N41756-11-C-3878 awarded by the Department of the Navy. The Government has certain rights in this invention.

### FIELD OF THE INVENTION

This disclosure relates generally to information gathering and more particularly to a technique to combine a plurality of short communications into a larger document to more readily understand the context of the overall communication.

### BACKGROUND

The growth of internet use in recent years has provided unparalleled access to informational resources. Over the past decade, social networking and microblogging services such as Facebook and Twitter have become popular communication tools among internet users, being employed for a wide range of purposes including marketing, expressing opinions, broadcasting events or simply conversing with friends. Thus, there has been a growth in development of rapid automatic processing technologies that not only provide insights but also keep up with the rate at which information is produced. Recent work has included sentiment analysis, mining coherent discussions, identifying trending topics, detecting events, etc. There is a need for technologies that can process content from these services, extract entities, sentiment, topics, location, etc., and enable linking the attributes, such as sentiment to topic, topic to location and such.

### SUMMARY

In accordance with the present disclosure, a document building system is provided including: a user interface device having access to a communication system having a plurality of short media message units available to collect the short media message units; memory to cache the short media message units in the system; a collator to collect a plurality of related short media message units among users over a predetermined period of time; and a user interface to output to a single file the plurality of related short media message units when the file reaches a predetermined size to construct a cohesive document or to output to a single file a plurality of related short media message units after a maximum predetermined period of time to construct a cohesive document.

In accordance also with the present disclosure, a method for constructing a cohesive document includes: accessing a communication system having a plurality of social media message units accessible; collecting a plurality of related social media message units among users over a predetermined period of time; outputting to a single file the plurality of related social media message units when the file reaches a predetermined size to construct a cohesive document or outputting to a single file a plurality of related social media message units after a maximum predetermined period of time to construct a different cohesive document.

The details of one or more embodiments of the disclosure are set forth in the accompanying drawings and the description below. Other features, objects, and advantages of the disclosure will be apparent from the description and drawings, and from the claims.

### DESCRIPTION OF DRAWINGS

FIG. 1 is a diagram of a social media message processing pipeline;

FIG. 2 is a simplified flow chart of a process to produce a document from a plurality of social media message units;

FIG. 3 is a time chart showing document creation from social media message units showing the documents produced at minimum and maximum periods of time;

FIG. 4 is a textual diagram describing the process of implementing the flow chart of FIG. 2;

FIG. 5 is a block diagram of a computer to implement a document building system using the techniques described herein.

FIG. 6 is a comparison between Twitter-provided geospatial information for Arabic tweets (shown on the map on the left) and English tweets (shown on the map on the right) on a world map showing the dominant tweets from the Middle East region based on a selected user network;

FIG. 7 is a processing flowchart for content-based geo-location showing all the stages, starting from tweets collection, document conversion, preprocessing and geo-location detection;

FIG. 8 is a textual diagram describing three phases of the content-based geo-location clustering and detection algorithm;

FIG. 9 is a map showing tweets matching the keyword “muslim brotherhood” where a dot in Egypt shows the region with largest number of hits;

FIG. 10 is a map showing tweets matching the keyword “roadside bomb” returning two prominent clusters of tweets circled, one in Iraq and other in Afghanistan; and

FIG. 11 is a map showing tweets matching the Hashtag #30June returned a large red cluster of tweets in Egypt, thereby, highlighting the protests in Egypt that happened on Jun. 30, 2013.

Like reference symbols in the various drawings indicate like elements.

### DETAILED DESCRIPTION

The present disclosure describes techniques to create cohesive documents from multiple social media message units (SMMUs) produced in services such as, Twitter, Facebook, Whatsapp and others. Documents are created based on content and themes from users, temporal information in content or metadata, geospatial information in content or metadata, and other attributes. The following description primarily discusses Twitter, but it should be appreciated that the description is also applicable to other services such as Facebook, Whatsapp and others that communicate with short bits and pieces or snippets of information.

The growth of Internet use in recent years has provided unparalleled access to informational resources. Micro-blogging services such as Twitter have become a very popular communication tool among Internet users, being employed for a wide range of purposes including marketing, expressing opinions, broadcasting events or simply conversing with friends.

Each day, more than 200 million active users publish more than 400 million tweets per day in the social network, sharing significant events in their daily lives. With such a large geographically diverse user base, Twitter has essentially published many terabytes of real-time sensor data in the form of status updates. Additionally, Twitter allows researchers and, government unprecedented access to digital trails of data as users share information and communicate online. This is helpful to parties seeking to understand trends and patterns ranging from customer feedback to the mapping of health pandemics. Hence, every Twitter user can be described as a sensor that can provide spatiotemporal information capable of detecting major events such as earthquakes or hurricanes or other man made or natural events.

Location and language are crucial attributes to understanding the ways in which online flow of information might reveal underlying economic, social, political, and environmental trends and patterns. Localization facilitates temporal analyses of trending news topics and events from a geospatial perspective, which is often useful in selecting localized events for further analysis. Studies have addressed the capability to track emergency events and how they evolve, as people usually first post news on Twitter, and are later broadcast by traditional media corporations. Alerts can be sent as soon as an emergency event is detected (known as First Story Detection—FSD), providing relevant information gathered from the conversations around it to the correspondent emergency response teams. One of the challenges to this process is identifying the location where the emergency is taking place.

Geospatial tagging features are certainly not new to Twitter, which has a check-in feature as most social networking sites do. This feature allows users to geographically tag their tweets by listing their location in their Twitter User Profile. Unfortunately, Twitter users have been slow to adopt such geospatial features. In our sampling of over approximately 3 million Twitter users; only 30% have listed user location, which include locations as granular as a city name (e.g. Riyadh, Saudi Arabia) to something overly general (e.g. Asia) and unhelpful (e.g. The World). In addition to location via user profile, Twitter supports per-tweet geo-tagging feature which provides extremely fine-tuned Twitter user tracking by associating each tweet with a latitude and longitude.

In a sampling of 17 million tweets over 1st quarter of 2013, less than 0.70% of all tweets actually use this functionality. When this feature is enabled, it generally functions automatically when a tweet is published with the coordinate data coming either from user's device itself via GPS, or from detecting the location of the user's Internet (IP) address. Additionally, neither of these Twitter-provided features for geo-location provides location estimates based on the textual content in the user-posted tweet messages. On the whole, the lack of adoption and availability of per-user and per-tweet geo-tagging features indicates that the capability of Twitter as a location-based sensing and information tracking tool may have only limited reach and impact. Additionally, these features do not provide location estimates based on the content of the user-posted tweet messages.

Although Twitter provides vast amounts of data, it introduces several natural language processing (NLP) challenges: Multilingual posts and code-switching between languages makes it harder to develop language models and may require Machine Translation (MT); With the limitation of 140 characters per-tweet, Twitter users often use shorthand and non-standard vocabulary which makes named-entity detection and geo-location via gazetteer more challenging, Tweets are inherently noisy and may contain limited information for geo-location detection on per-tweet basis; Twitter content tends to be very volatile, and pieces of content become popular and fade away within a matter of hours.

It should be appreciated, using the Twitter Spritzer streaming API, with a filter to differentiate selected users of interest, one can access multiple social media message units among users. The Twitter Spritzer feed streams approximately 1% of the entire world's tweets in real-time. One can then additionally filter further down-samples the 1% feed into tweets within the users' network, which includes tweets based on user mentions and re-tweets, in addition to the tweets from the selected users. Further information on accessing streaming can be found at https//dev.twitter.com/docs/streaming-apis and http://blog.gnip.com/tag/spritzer/.

A technique of collating a group of tweets into a document structure based on parameters such as user's tweeting frequency, and, minimum and maximum time window over which the topic of interest (such as a news topic) is expected to evolve, trend and fade in the Twittersphere will now be described. Once the document is defined, further processing such as analysis by NLP and Information Extraction (IE) algorithms can be performed to further gleam information from the content of the document.

The motivation for defining a document is two-fold: (1) as a single tweet is limited to 140 characters, it may not have sufficient textual content to understand the significance that corresponds to a specific topic (or a news story), and, (2) most Twitter users post tweets on specific trending topics and move on to other topics within a certain temporal window. Content from social media sites, such as Twitter, Facebook, WhatsApp, is produced in small snippets or posts and often a complete story is expressed over multiple posts. Running natural language processing (NLP) and information extraction (IE) algorithms on small snippets of content becomes challenging, since the algorithms may not have sufficient context to produce useful output. A new method has been developed to create cohesive documents from multiple social media message units (SMMUs) based on content and themes from users, temporal and geospatial information in content and metadata, and other attributes or combination of attributes. The NLP algorithms run on these cohesive documents instead of SMMUs to produce improved named entity recognition, sentiment analysis, geolocation, and machine translation.

There are several advantages of this approach over traditional techniques that work on SMMUs or a group of SMMUs. The cohesive document produced by the present method contains the contextual information that may be present in a SMMU. Since a typical conversation spans over several SMMUs among multiple users, combining the SMMUs produces documents analogous to text documents that present a cohesive narrative. Moreover the document size can be tuned based either on the SMMU attributes, such as frequency at which SMMUs are produced, time windows, users, hashtags or the requirements of NLP and IE algorithms.

Shallow processing technologies designed for “big data” can deal with volume, velocity, variety of the data, but lack the richer and in-depth analysis provided by natural language processing (NLP) and information extraction (IE) algorithms. The present disclosure defines a process for creating cohesive documents from the content produced on social networking and microblogging services. NLP and IE techniques can then be employed on documents instead of the message units.

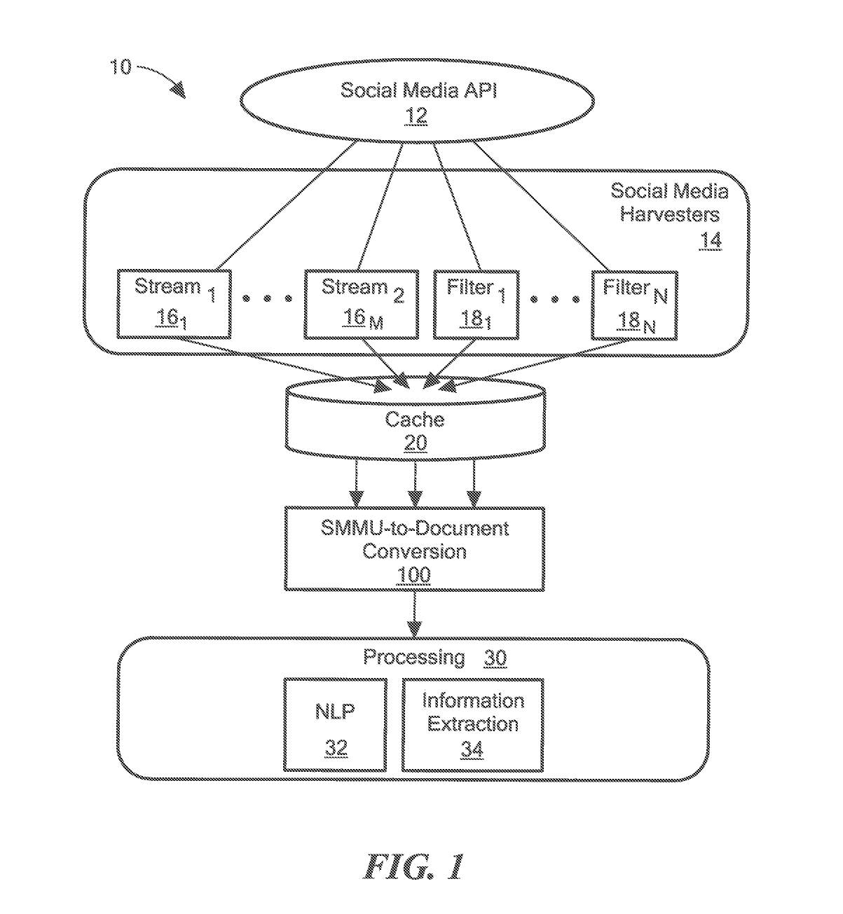

Referring now to FIG. 1, a diagram of a social media message processing pipeline is shown to include a pipeline 10 to process the content or social media message units (SMMUs) disseminated by social media services such as Twitter. The pipeline 10 includes social media harvesters 14, cache 20, SMMU-to-Document conversion 100 and processing 30 as shown in FIG. 1. Social media sites (not shown) provide content to application programming interface (API) 12 to harvest content from the social media sites, which can be grouped into two modes: streaming and filtering. Streaming APIs 16₁ to 16_{M} provide access to stream of data produced by the services, and filtering APIs 18₁ to 18_{N} allow setting filters and requesting specific content based on predefined attributes. The pipeline supports harvesting content from both modes and saving it to a cache 20. Caching mechanism provides three features: 1) saving large amount of harvested SMMUs; 2) retrieval based on attributes; and 3) trimming processed and superfluous SMMUs. SMMU-to-Document conversion algorithm 100 picks SMMUs from the cache 20 and creates a list of documents, which can be used for NLP (natural language processing) 32 and information extraction 34.

As described above, individual SMMUs may not provide enough information to understand the content of a conversation so by converting SMMUs into a cohesive document unit that can be used as a subject of analysis by NLP and Information Extraction (IE) algorithms, a better analysis of the SMMUs can be accomplished. The motivation for defining the document is two-fold; (1) as a single message is often limited, for example 140 characters in case of Twitter, and it may not have sufficient textual content for understanding the information that corresponds to a specific topic (or a news story), and, (2) most users post messages on specific trending topics and move on to other topics within a certain temporal window.

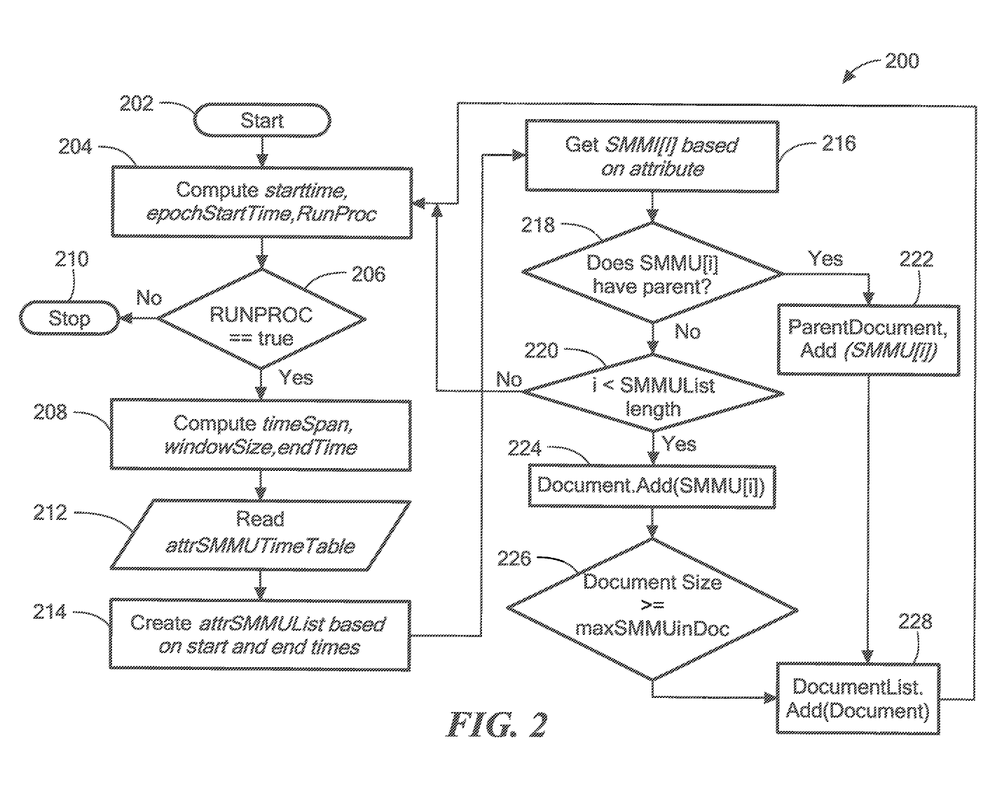

Referring now to FIG. 2, a simplified flowchart for a document creation process 200 for creating a list of documents (DocumentList) from SMMUs during a time-span is shown. Two time windows are defined: a smaller window, which is used to create documents from SMMUs based on document size criteria and a larger window or an epoch, during which all the SMMUs get processed even if they don't meet the criteria. The approach ensures that all the SMMUs get processed within an epoch window. For example, the smaller window may be set for four hours and the larger window may be set for twenty four hours. The document creation process 200 runs continuously on the collected SMMUs. During the small window timeframe defined by the minWindowSize parameter, a set of SMMUs pertaining to an attribute, which can be a user posting messages, a discussion thread, or messages coming from a location, etc., are extracted.

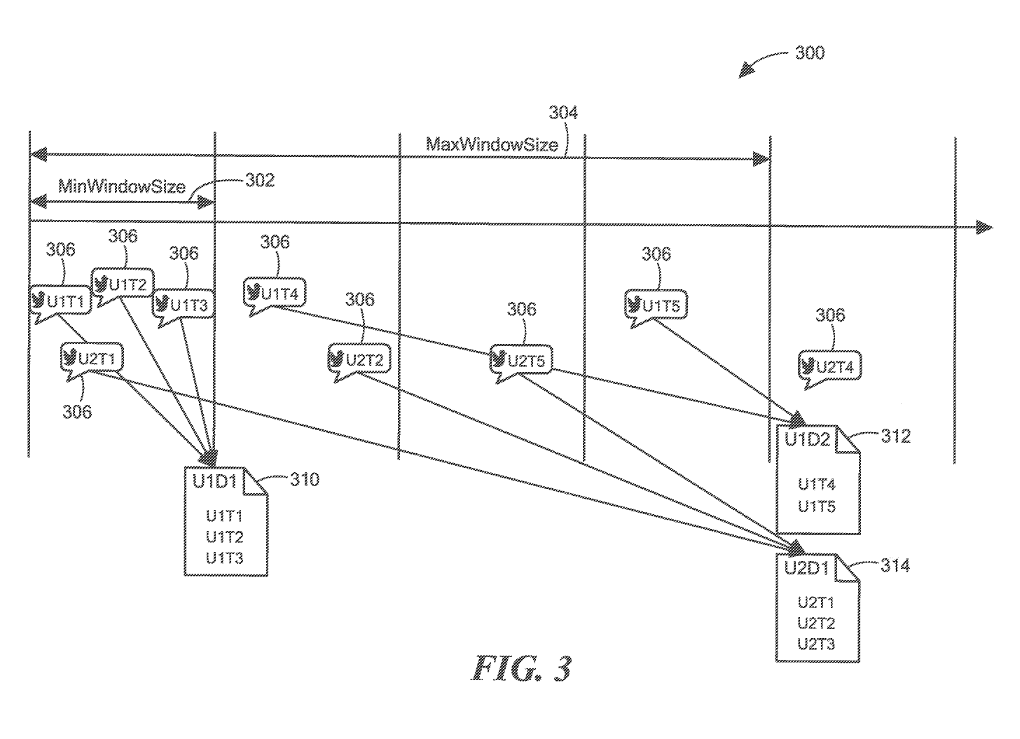

If the set of SMMUs meets the document creation criteria, then a document gets created and added to the document list (DocumentList) for NLP processing 32 (FIG. 1). FIG. 3 is a time chart showing document creation from short message units shows the documents created at during both the windows as to be described further hereinbelow. Note that all the SMMUs are processed at the MaxWindowSize or when an epoch completes. The technique has been applied to geo-locate tweets and effectively identify trending topics, geo-political entities and hashtags by location as well as applied to other content attributes.

Referring again now to FIG. 2, a simplified flowchart showing a document creation process 200 for creating a list of documents will be described. Process 200 begins with a start command as shown by block 202. Next, a Compute starttime, epochStarttime, RunProc command is executed as shown by block 204. Next, decision block 206 determines if the necessary information is available to run the procedure and if not, the process 200 is stopped as shown by block 210, otherwise the process 200 continues. A compute timeSpan, windowSize, endTime command is executed as shown by block 208. Here, the time span is computed by subtracting the starttime from the epochStarttime. The window size is set to maximum window size if timespan is greater than maximum window size; otherwise it is set to minimum window size. For example, the minimum window size can be set to four hours and the maximum window size can be set to 24 hours. Other durations of time can be used depending on the environment. A Read attrSMMUTime Table command is executed as shown in block 212. Next, a Create attrSMMUList based on start and end times command is executed as shown in block 214. As shown in block 216, a Get SMMU(i) based on attribute command is executed where an individual SMMU is retrieved based on the desired attribute, so that the SMMU can be added to an applicable document according to the attributes used to select SMMUs. Next, at decision block 218, it is determined if the SMMU has a parent document meaning have other SMMUs already been identified with the same attributes and a document has already been created. If the answer is yes, then as shown in block 222, the SMMU is added to the parent document, and the document is added to the document list as shown in block 228. If the answer is no, then as shown in decision block 220 it is determined if the number of SMMUs have met the minimal number of SMMUs required to create a new a document. If the answer is no, then next set SMMUs are extracted as shown in block 204 and the process 200 continues. If the answer is yes, then a document is added with the identified SMMUs having the attributes associated with that document as shown in block 224. As time continues, as shown in decision block 226, the to document size is checked and once the document size exceeds a predetermined maximum size, the document is added to the document list as shown in block 228 and further SMMUs having the same attributes will then be added to a new document. The process 200 will continue until the time of the maximum window size is reached where at that time documents will be created and all SMMUs having attributes that have been identified as being of interest will be added to the applicable document and then the process will start again for the next period of time.

Referring now to FIG. 3, a time chart showing document creation process 300 from social media message units 306 with the documents 310, 312 and 314 produced at minimum and maximum periods of time. As described above with process 200, a minimum window size 302 for a minimum period of time is set where during this time SMMUs 306 having particular attributes are captured and once the minimum window size is met and the number of SMMUs have reached a predetermined number, a document 310 is created including the applicable SMMUs 306 with the corresponding attributes. In addition, a maximum window size 304 is set for a maximum period of time where at the end of this time, any other SMMUs of interest that have not yet been added to a document are captured and a document is created with those SMMUs. As shown in FIG. 3, a first set of attributes associated with a set of SMMUs are identified as U1 where U1 identifies the SMMUs associated with the first set of attributes and T1 . . . T5 identifies which SMMU is being identified. Here, SMMUs U1T1, U1T2, U1T3, U1T4 and U1T5 all match the first set of attributes. In the example, a first document U1D1 is created and then later document U1D2 is created where both documents U1D1 and U1D2 are related to the same set of attributes. In addition, a second set of SMMUs with a second different set of attributes are identified as U2 where U2 identifies the SMMUs associated with the second set of attributes and T1 . . . T3 identifies which SMMU is being identified. Here SMMUs U2T1, U2T2, and U2T3 all match the second set of attributes and document U2D1 is created from SMMUs U2T1, U2T2, and U2T3. It should be appreciated FIG. 3 is simplified to explain the technique of creating documents where in most situations, the total number of SMMUs will be larger and the number of SMMUs used to create a document will be larger.

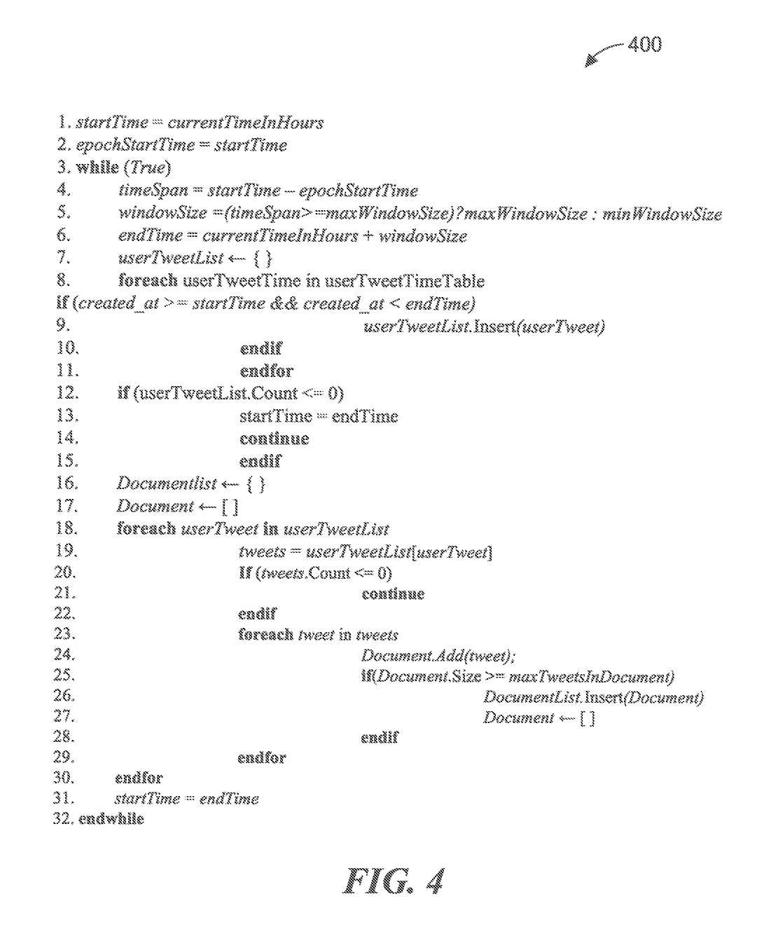

A tweets-to-document generation process 400 is formulated in Algorithm 1 and is shown in text form in FIG. 4. The terminology used in Algorithm 1 is as follows:

Input:

tweets: List of n tweets from m Twitter users in time window t

minWindowSize: The minimum size of the time window in hours

maxWindowSize: The maximum size of the time window in hours

minTweetsInWindow: The minimum number of tweets per-user in a time window

maxTweetsInDocument: The maximum number of tweets allowed in a document

Output:

documentList: List of documents in time window t

Notation: { }—List, [ ]—Array

Once all the tweets in a time-delineated window are converted into documents, such that each document contains multiple tweet posts from a specific user, each document can be further processed using NLP and Information Extraction as necessary.

It should be appreciated in addition to the technique described to text produced on social networking, microblogging and chat services, the technique can be extended to other domains and modes. The document creation technique can be extended to audio and speech processing where we can create an audio document from many short segments of audio or conversation. The technique can be further applied on videos generated on video-sharing and video-blogging sites. In general this can be applied to content that has well-defined attributes and is produced over a period of time.

Having described a document building system using a service such as Twitter, one may implement such a system for gathering information. In one environment, the system can be used to capture information from first responders when responding to an incident. Each first responder can be assigned a Twitter account and each account can be configured with a certain set of attributes. As can be appreciated, when first responders respond to an incident and report to the chain of command providing situational awareness, it can be difficult to collect and verify the accuracy of the information during the initial period of response. By using a service such as Twitter or the like instead of hand held voice communication radios, first responders can tweet information (send SMMUs) to the team and the team's leadership and using the document building system as taught herein, documents can be created from the SMMUs that can then be analyzed by intelligence personnel to collect information and provide cohesive information to the decision makers so that the decision makers can provide guidance and instructions. In another environment, the SMMUs generated in the geographical area of a significant event can be captured and cached and a set of attributes can be set and those SMMUs meeting the set of attributes can then be captured and documents created accordingly. The created documents can then be analyzed using natural language processing techniques or information extraction techniques to gleam information of interest.

According to the disclosure an article includes: a non-transitory computer-readable 20 medium that stores computer-executable instructions, the instructions causing a machine to: access a communication system having a plurality of social media message units available; collect a plurality of related social media message units among users over a predetermined period of time; output to a single file the plurality of social media message units when the file reaches a predetermined size to construct a cohesive document; and output to a single file the plurality of related social media message units after a maximum predetermined period of time to construct a cohesive document. Furthermore, a method for constructing a cohesive document includes: accessing a communication system having a plurality of social media message units accessible; collecting a plurality of related social media message units among users over a predetermined period of time; outputting to a single file the plurality of related social media message units when the file reaches a predetermined size to construct a cohesive document; and outputting to a single file a plurality of related social media message units after a maximum predetermined period of time to construct a different cohesive document.

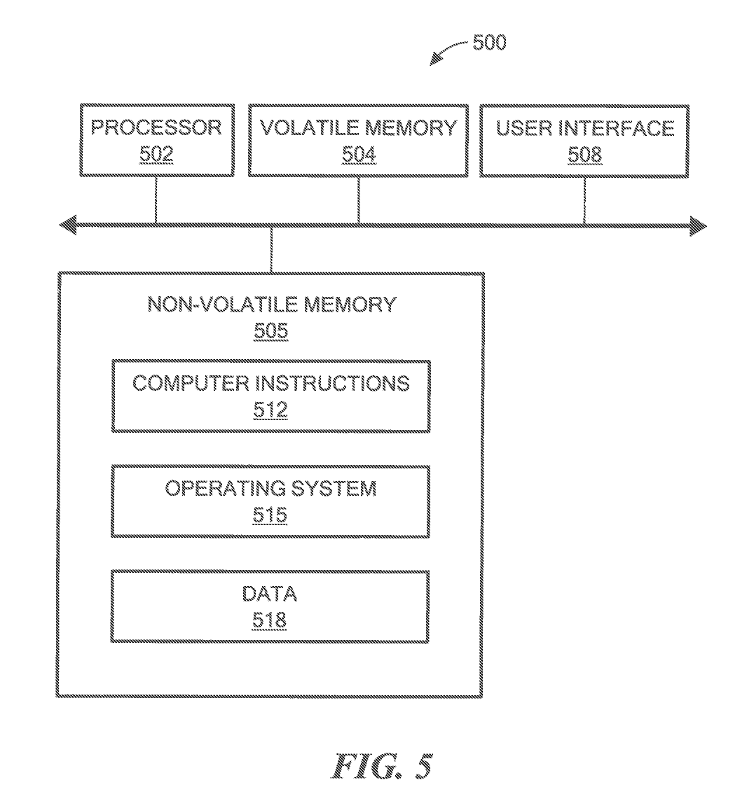

Referring to FIG. 5, a computer includes a processor 502, a volatile memory 504, a non-volatile memory 506 (e.g., hard disk) and the user interface (UI) 508 (e.g., a graphical user interface, a mouse, a keyboard, a display, touch screen and so forth). The non-volatile memory 506 stores computer instructions 512, an operating system 516 and data 518. In one example, the computer instructions 512 are executed by the processor 502 out of volatile memory 504 to perform all or part of the processes described herein.

The processes and techniques described herein are not limited to use with the hardware and software of FIG. 5; they may find applicability in any computing or processing environment and with any type of machine or set of machines that is capable of running a computer program.

The processes described herein may be implemented in hardware, software, or a combination of the two. The processes described herein may be implemented in computer programs executed on programmable computers/machines that each includes a processor, a non-transitory machine-readable medium or other article of manufacture that is readable by the processor (including volatile and non-volatile memory and/or storage elements), at least one input device, and one or more output devices. Program code may be applied to data entered using an input device to perform any of the processes described herein and to generate output information.

The system may be implemented, at least in part, via a computer program product, (e.g., in a non-transitory machine-readable storage medium such as, for example, a non-transitory computer-readable medium), for execution by, or to control the operation of, data processing apparatus (e.g., a programmable processor, a computer, or multiple computers)). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a non-transitory machine-readable medium that is readable by a general or special purpose programmable computer for configuring and operating the computer when the non-transitory machine-readable medium is read by the computer to perform the processes described herein. For example, the processes described herein may also be implemented as a non-transitory machine-readable storage medium, configured with a computer program, where upon execution, instructions in the computer program cause the computer to operate in accordance with the processes. A non-transitory machine-readable medium may include but is not limited to a hard drive, compact disc, flash memory, non-volatile memory, volatile memory, magnetic diskette and so forth but does not include a transitory signal per se.

The processes described herein are not limited to the specific examples described. Rather, any of the processing blocks as described above may be re-ordered, combined or removed, performed in parallel or in serial, as necessary, to achieve the results set forth above.

The processing blocks associated with implementing the system may be performed by one or more programmable processors executing one or more computer programs to perform the functions of the system. All or part of the system may be implemented as, special purpose logic circuitry (e.g., an FPGA (field-programmable gate array) and/or an ASIC (application-specific integrated circuit)). All or part of the system may be implemented using electronic hardware circuitry that include electronic devices such as, for example, at least one of a processor, a memory, a programmable logic device or a logic gate.

Having described a document building system to gather information, we will now discuss a process to identify social media users across the Middle East who are influential contributors on the Twitter social media platform. The goal was to identify a total of 300-350 users selected from countries across the region, with the distribution roughly matching the population of each country. Through this process, a list of Twitter users was created, culled from mainstream journalism feeds, diplomatic circles, and political circles having wide Arabic regional appeal.

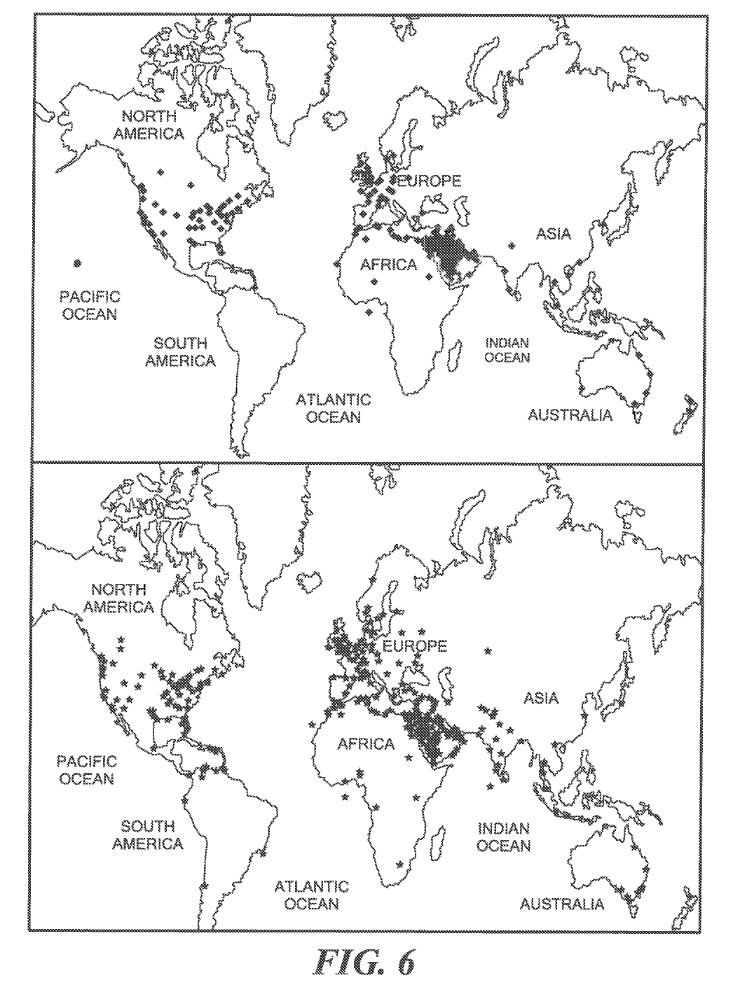

Tweets were collected over a period of 3 months using the Twitter Spritzer streaming API with a filter for selected users of interest. The Twitter Spritzer feed streams approximately 1% of the entire world's tweets in real-time. The users filter further down-samples the 1% feed into tweets within the users' network, which includes tweets based on user mentions and re-tweets, in addition to the tweets from the selected users. Using this setup, approximately 17 million multilingual tweets were collected distributed into 85% Arabic, and 15% English from 2.6 million Twitter users as shown in FIG. 6. FIG. 6 is a comparison between Twitter-provided geospatial information for Arabic tweets (shown on the map on the left) and English tweets (shown on the map on the right) on a world map showing the dominant tweets from the Middle East region based on a selected user network. The collected data includes geospatial information in the users' profile and within individual tweets.

To measure the performance of the tweet geo-location detection algorithm, evaluation across two dimensions were performed; (1) compare the estimated tweet geo-location with the device-based geospatial data, and, (2) compare the estimated tweet geo-location versus the geo-location of user that posted the tweet. The first metric we consider is the error distance, which quantifies the distance in miles between the actual geo-location of the tweet l_{act}(t) and the estimated geo-location lₑₛₜ(t). The Error Distance for tweet t is defined as:

ErrDist(t)=d(l_{act}(t),lₑₛₜ(t)) Eq. 1

The overall performance of the content-based tweet geo-location detector can further be measured using the Average Error Distance across all the geo-located tweets T using Equation (2):

$$AvgErrDist ( t ) = \frac{{\sum }_{t ∈ T} ErrDist ( t )}{\vert T \vert} \qquad Eq . 2$$

A low Average Error Distance indicates that the geo-location detector can geo-locate tweets close to their geo-location on average as provided by the user profile or user device. This metric does not provide more insight into the distribution of the geo-location detection errors. We apply maximum allowed distance in miles thresholding at three points; 100 miles, 500 miles and 1000 miles and calculate the next metric, Accuracy₁₀₀, Accuracy₅₀₀ and Accuracy₁₀₀₀ using Equation (3):

$${Accuracy}_{K} ( T ) = \frac{\vert t \vert t ∈ ErrDist ( t ) \leq K}{\vert T \vert} \qquad Eq . 3$$

where K is distance in miles.

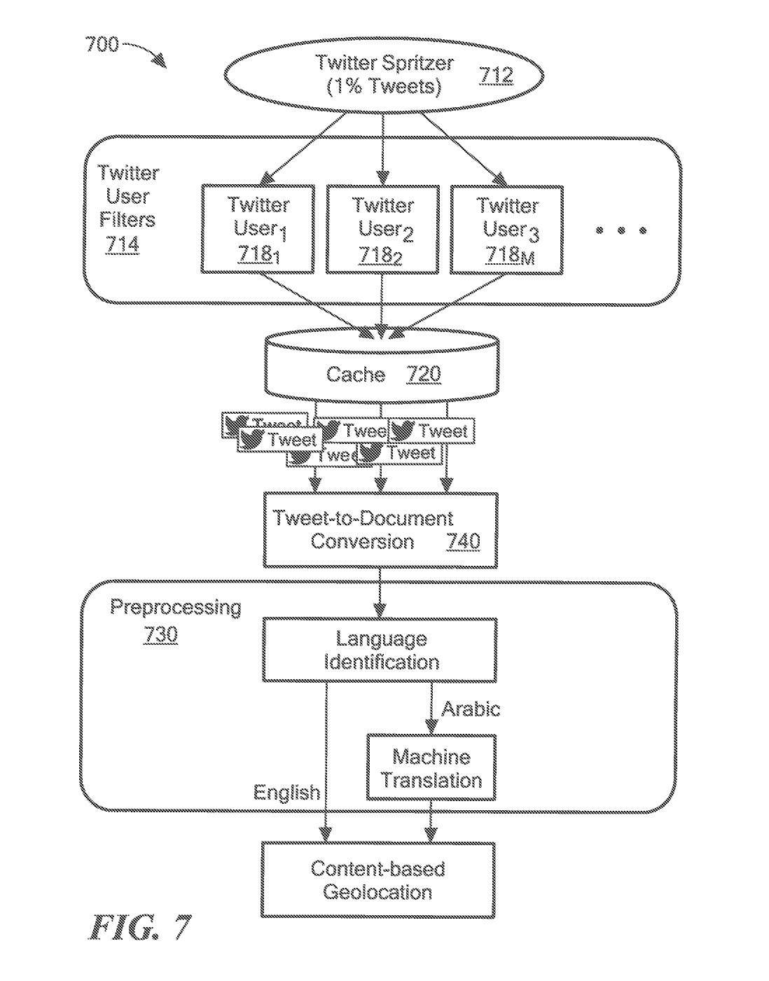

Referring now to FIG. 7, an approach for content-based geo-location clustering and detection is shown. First we define a method for collating a group of tweets into a document structure based on parameters such as user's tweeting frequency, and, minimum and maximum time window over which we expect the news topics to evolve, trend and fade in the Twittersphere. Once the Document is defined, we present our content-based geo-location algorithm and the pro-processing steps such as language identification and machine translation that are performed before the content-based geo-location clustering and detection algorithm. A diagram of a social media message processing pipeline is shown to include a pipeline 700 to process the content or social media message units (SMMUs) disseminated by social media services such as Twitter shown here from Twitter Spritzer and captured by an API 712. The pipeline 700 includes filters 714, cache 720, Tweet-to-Document conversion 740 and preprocessing 730 as shown in FIG. 7. Twitter Spritzer provides content to application programming interface (API) 712 to harvest content from the social media site. Filtering APIs 718₁ to 718_{M} allow setting filters and requesting specific content based on predefined attributes. The pipeline supports harvesting content and saving it to the cache 720. Caching mechanism provides three features: 1) saving large amount of harvested tweets; 2) retrieval based on attributes; and 3) trimming processed and superfluous tweets. Tweet-to-Document conversion algorithm 740 picks tweets from the cache 720 and creates a list of documents, which can be processed by preprocessor 730 where the language of the tweets can be indentified and using machine translation converted to another language such as English.

As described above, the motivation for defining the Document was two-fold; (1) as a single tweet is limited to 140 characters, it may not have sufficient textual content for estimating location that corresponds to a specific topic (or a news story), and, (2) most Twitter users post tweets on specific trending topics and move on to other topics within a certain temporal window. Hence it is desirable to provide this tweets-to-document generation as formulated in the algorithm as show in FIG. 4 and shown in the schematic in FIG. 7.

Referring again to FIG. 7, once all the tweets in a time-delineated window are converted into documents, such that each document contains multiple tweet posts from a specific user, we preprocess all the documents as shown in Block 730 in preparation for content-based geo-location detection. First, we perform n-gram based language identification to identify Arabic versus English tweets and translate Arabic tweets into English using the SDL Language Weaver Machine Translation (MT) system. The geo-location detection algorithm operates on source English tweets and the MT-English equivalent of the Arabic tweets. It is to be noted that the accuracy of our geo-location detector is determined by the quality of the machine translation or by operating directly on source language text.

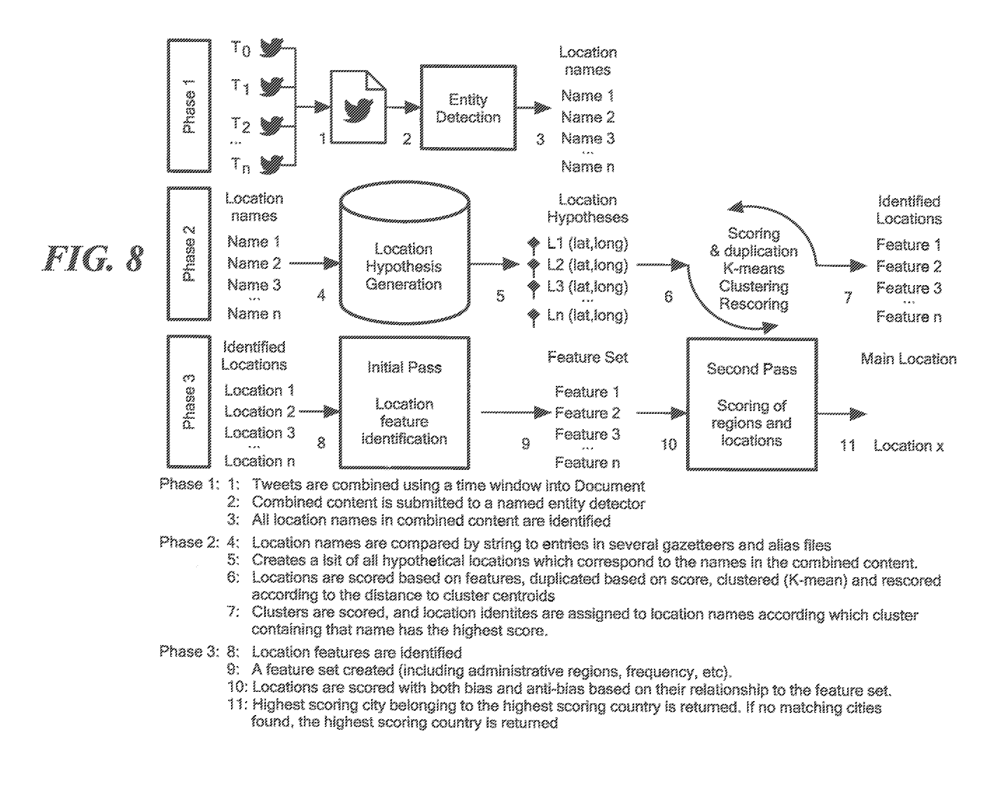

Our geo-location detection algorithm has three distinct phases as shown in FIG. 8. In the first phase, tweets that were grouped into a time-delineated content window via the document generation algorithm described above are submitted to a named entity detection algorithm. All location names in combined content are identified.

In phase two, individual locations are identified. In this phase, the list of named entities which were discovered in phase one is now employed to select location records from several gazetteers. This selection is sometimes enhanced with an alias file that provides supplementary information. Each match is then given a preliminary score based on features both internal to the location record and features from external sources. Points are then duplicated proportionally to their scores to create a weighting scheme for k-means clustering. The randomly assigned points are then rescored based on how close they are to their cluster's center or centroid location. Prior to each k-means iteration, the points are reassigned to whichever cluster has the nearest centroid to that point. When clusters are stable, they are scored. Finally, location identities are assigned to location names according to their membership in the cluster with the highest score containing that name.

The third and last phase of the system is concerned with selecting the best overall location associated with the document. This phase begins by iterating through the locations identified in the previous step. During this initial pass, common features such as political administrative unit membership are identified, as well as other features such as order of occurrence. In a second pass, each location is scored by comparing it to the results of the first pass; certain features are biased and others receive an anti-bias. After each point is scored, the highest scoring city belonging to the highest scoring country is returned. If no matching cities are found, the highest scoring country is returned as the estimated location.

A goal is to measure the accuracy of content-based geo-location of tweets against both the device-based tweet geo-location as well as the user profile-based geo-location. A key point to be noted is that we are measuring the performance of a content-based geo-location detector against geospatial data that is based solely on either the location of the users where they were tweeting from or their location when they created their Twitter profile. While these results help us assess the performance of geo-location detector, we believe that creating a manually annotated set would allow use to demonstrate greater accuracy. This is due to the discrepancy between a user's physical location and the subjects a user may be tweeting about. For example, a user with profile provided location of Boston, Mass., USA might be traveling in Egypt, while tweeting about trending news in Syria.

As mentioned previously, Twitter offers a per-tweet geo-tagging feature which provides extremely fine-tuned user tracking by associating each tweet with a latitude and longitude. In our sampling of 17 million tweets over 1st quarter of 2013, less than 0.70% of all tweets actually use this functionality. To minimize outliers, we filtered tweets that are from potential spammers based on 2 criteria; (1) filter tweets that are not from our core selected users, and, (2) filter tweets that are auto-generated by advert spreading tools. After filtering, we had approximately 50K tweets with Twitter-provided device-based geospatial data in terms of latitude and longitude points.

Table 1 shows the results of our content-based geo-location detection algorithm using the average distance error and accuracy metrics defined above.

TABLE 1

| AvgErrDist | | | |
|---|---|---|---|
| (Miles) | Accuracy₁₀₀ | Accuracy₅₀₀ | Accuracy₁₀₀₀ |
| 1881.98 | 0.122 | 0.321 | 0.497 |

We found that only 12% of the 50K tweets in the test set could be geo-located within 100 miles of their device-provided geospatial points and that the AvgErrDist across all 50K was 1,881 miles. The accuracy does improve close to 50% for tweets that could be geo-located within 1000 miles of their device-provided location.

Twitter geo-tagging feature allows users to geographically tag their tweets by listing their location in their Twitter User Profile. Unfortunately, Twitter users have been slow to adopt such geospatial features. In our sampling of over approximately 3 million Twitter users; only 30% have listed user location, which include locations as granular as a city name (e.g. Riyadh, Saudi Arabia) to something overly general (e.g. Asia) and unhelpful (e.g. The World). We further filtered this set of users to consider only our core selected Middle East users who provided valid location (city/country) names in their user profiles. Further, we resolved the location names to geospatial points using the Google Maps API4. Based on this, we had 325 users with valid geospatial information which we then transferred to the 50K tweets that we had selected as our test set above. Table 2 shows the results of our content-based geo-location detector using user profile based geo-location as reference.

TABLE 2

| AvgErrDist | | | |
|---|---|---|---|
| (Miles) | Accuracy₁₀₀ | Accuracy₅₀₀ | Accuracy₁₀₀₀ |
| 253.24 | 0.09 | 0.221 | 0.386 |

We found that only 9% of the 50K tweets in the test set could be geo-located within 100 miles of their user profile provided geospatial points and the AvgErrDist was 2,053 miles. In comparison to the device-based evaluation, the Accuracy100 degraded relatively by 75%. This result indicates that our core users who are contribute to mainstream journalism feeds, diplomatic circles, and political circles having wide Arabic regional appeal, and, their tweeting profile varies from their user profile which was created when they opened an account with Twitter. For our baseline evaluation, we set the parameters min WindowSize and max Win-dowSize of our Tweet-to-Document generation (FIG. 4) to 4 hours and 8 hours respectively. These values were motivated by an initial assessment that users tweet on a specific topic for a short period and move on to other topics of interest that are trending on that specific day. The maxWindowSize parameter controls the maximum time window allowed for the user's tweets such that they are considered localized to specific topic or news story.

In Table 3, we present some results with variation of these parameters and analyze the impact on the content-based geo-location detection performance. Our main motivation for varying these parameters was that the user tweeting frequency varies depending on the time of the day, trending news stories on that day as well as other factors pertaining to users' work schedule.

TABLE 3

| | AvgErrDist | | | |
|---|---|---|---|---|
| Method | (Miles) | Accuracy₁₀₀ | Accuracy₅₀₀ | Accuracy₁₀₀₀ |
| Baseline | 1881.98 | 0.122 | 0.321 | 0.497 |
| (min: 4. | | | | |
| max: 8) | | | | |
| Variant 1 | 773.43 | 0.313 | 0.392 | 0.574 |
| (min: 2. | | | | |
| max: 8) | | | | |
| Variant 2 | 693.24 | 0.377 | 0.412 | 0.581 |
| (min: 2. | | | | |
| max: 4) | | | | |

In Variant 1, we changed min WindowSize parameter from 4 hours to 2 hours which reduced the contextual time window, leading to smaller length documents localized to tweeting profile in the 2-hour window. The max WindowSize parameter was not changed in this experiment. We noticed that the Accuracy100 increased by 156% relative to our baseline parameters and the AvgErrDist also reduced to 773 miles from 1,881 miles. This improvement indicates that, even though shorter time window leads to smaller length documents, the content is more localized to a specific city/country as compared to the larger 4-hour window which might have content from topics pertaining to more than one location.

In Variant 2, we changed both, the min WindowSize and max WindowSize parameters to 2 hours and 4 hours respectively. This lead to a further improvement in Accuracy100; 209% relative to baseline and 20% relative to Variant 1. This improvement indicates that a time window of 4 hours leads to a more optimal context for all tweets that pertain to topic or news story. Content-based geo-location detection has many applications in the sector of advertising and user modeling. Our application of content-based geo-location detection is to segregate tweets pertaining to specific hashtags or trending news story and localize than on the global map. Such geo-location leads to detection of news or events that are trending in a specific city, country or region.

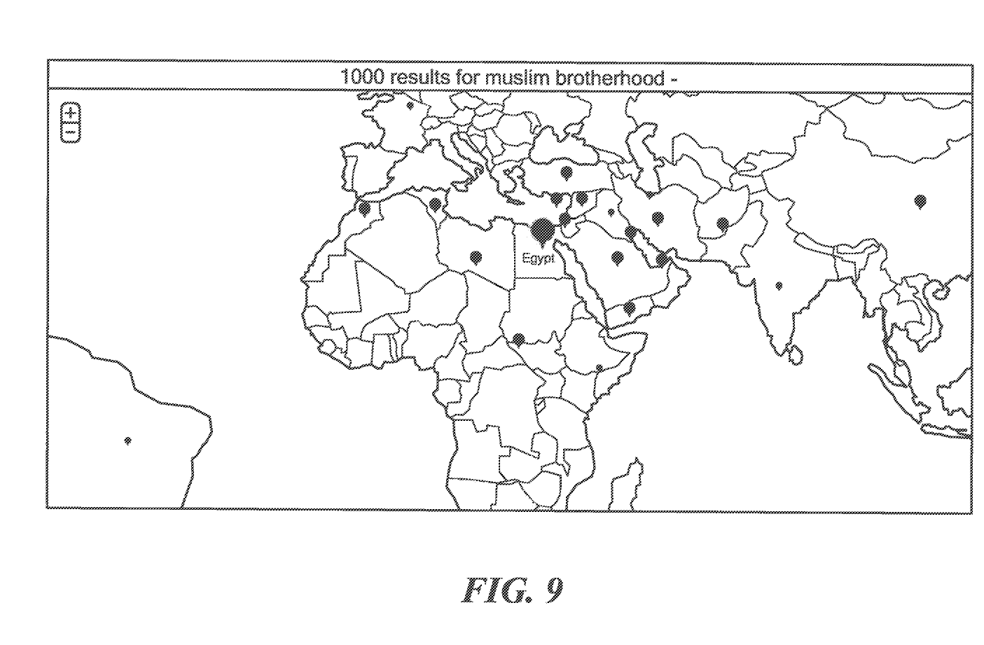

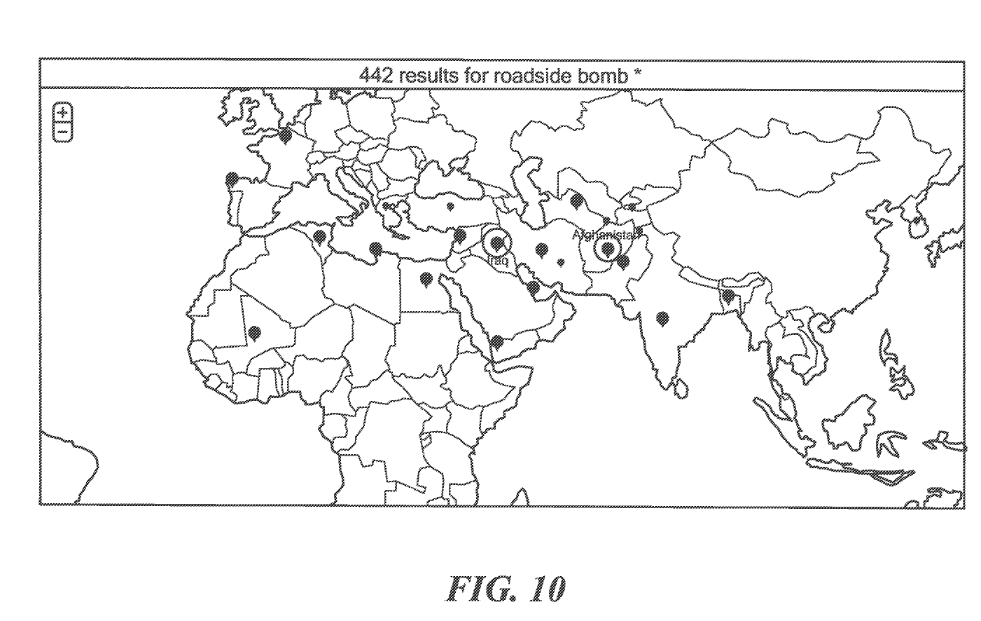

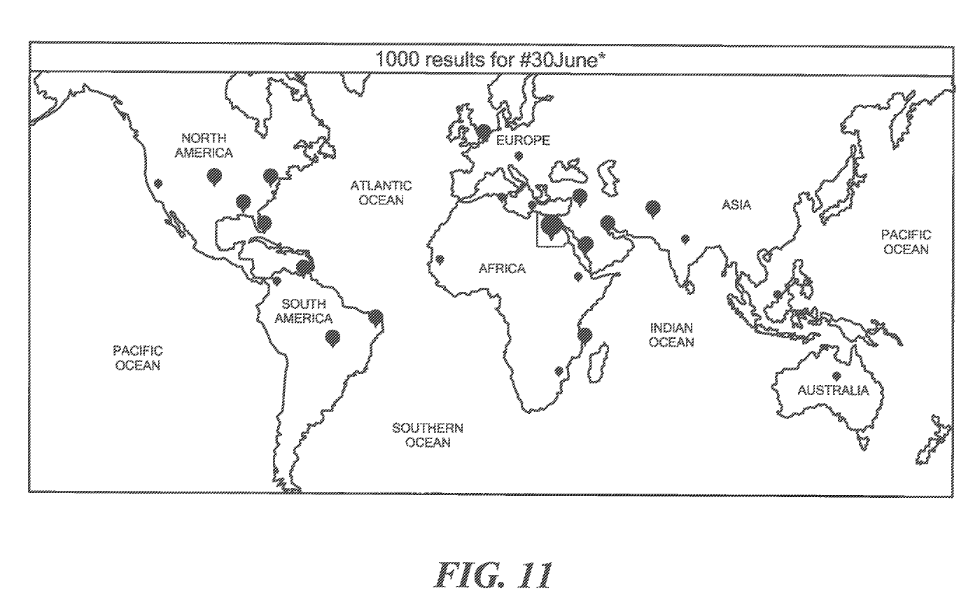

FIGS. 9, 10 and 11 show examples of trends-on-map application that we developed using the output of our content-based geo-location detector. In the example showed in FIG. 9, we searched our database of more than 20 million tweets using the keyword “muslim brotherhood” and displayed the top 1000 tweet results on the global map. As expected, the largest number of hits for this keyword query put the tweets on Egypt. FIG. 10 shows an example of an event “roadside bomb” that was trending in and around countries in Middle East on Jul. 3, 2013 and Google News reported roadside bombs in Baghdad, Afghanistan and southern Thailand. Our search of this keyword returned tweets that are displayed on the map shown in FIG. 10. The majority of tweets are distributed around Afghanistan and Iraq with a few outliers that mention the keyword “roadside bomb” and are geo-located in India and Yemen. One point to be noted here is that the expanded tweet from Iraq has the location names Iran and Afghanistan and it is geo-located in Iraq. This is the artifact of our time-delineated Tweet-to-Document generation which makes geo-location estimation from a group of tweets instead of one tweet alone. FIG. 11 shows an example of a Twitter Hashtag #30June that was trending during Jul. 3, 2013 and pertained to trending event “protests in Egypt” that happened on Jun. 30, 2013.

It should now be appreciated a cohesive document building system according to the disclosure includes: a user interface device having access to a communication system having a plurality of short media message units available to collect the short media message units; memory to cache the short media message units in the system; a collator to collect a plurality of related short media message units among users over a predetermined period of time; and a user interface to output to a single file the plurality of related short media message units when the file reaches a predetermined size to construct a cohesive document or to output to a single file a plurality of related short media message units after a maximum predetermined period of time to construct a cohesive document.

The document building system may include one or more of the following features independently or in combination with another feature to include caching mechanism that supports harvesting content from online social networking and microblogging services; generating documents from SMMUs based on specific attributes, such as users, location, specific words; creating documents by collating SMMUs from multiple languages; incorporating the temporal aspects (i.e. relating to the tense or the linguistic expression) of the message in document creation; multi-phased windowing approach to handle processing based on attribute-SM MU distribution; online algorithm that runs on streaming data; and temporal windows and size of documents which can be tuned to control the quality of NLP and IE.

Elements of different embodiments described herein may be combined to form other embodiments not specifically set forth above. Other embodiments not specifically described herein are also within the scope of the following claims.

What is claimed is:

1. An article comprising:
a non-transitory computer-readable medium that stores computer-executable instructions, the instructions causing a machine to:
access a communication system having a plurality of social media message units available;
collect a plurality of related social media message units among users over a predetermined period of time; and
output to a single file the plurality of social media message units to construct a cohesive document.

2. The article as recited in claim 1 wherein the cohesive document is constructed when the file reaches a predetermined size.

3. The article as recited in claim 1 wherein the cohesive document is constructed after a maximum predetermined period of time.

4. The article as recited in claim 1 wherein the cohesive document is constructed from related short media message units based on specific attributes such as one of users, location, and specific words.

5. The article as recited in claim 1 wherein the cohesive document is constructed from related short media message units from multiple languages.

6. The article as recited in claim 1 wherein temporal windows and size of documents are tuned to control the quality of natural language processing and information extraction.

7. A cohesive document building system comprising:
a user interface device having access to a communication system having a plurality of short media message units available to collect the short media message units;
memory to cache the short media message units in the system;
a collator to collect a plurality of related short media message units among users over a predetermined period of time; and
a user interface to output to a single file the plurality of related short media message units to construct a cohesive document.

8. The cohesive document building system as recited in claim 7 wherein the cohesive document is constructed when the file reaches a predetermined size.

9. The cohesive document building system as recited in claim 7 wherein the cohesive document is constructed after a maximum predetermined period of time.

10. The cohesive document building system as recited in claim 7 wherein the memory comprises a caching mechanism that supports harvesting content from online social networking and microblogging services.

11. The cohesive document building system as recited in claim 7 wherein the cohesive document is constructed from related short media message units based on specific attributes such as one of users, location, and specific words.

12. The cohesive document building system as recited in claim 7 wherein the cohesive document is constructed from related short media message units from multiple languages.

13. The cohesive document building system as recited in claim 7 wherein the cohesive document incorporates temporal aspects of a message in document creation.

14. The cohesive document building system as recited in claim 7 wherein the collator uses a multi-phased windowing approach to handle processing based on attribute short media message units distribution.

15. The cohesive document building system as recited in claim 7 wherein temporal windows and size of documents are tuned to control the quality of natural language processing and information extraction.

16. The cohesive document building system as recited in claim 7 wherein the short media message units are tweets from a twitter feed.

17. A method for constructing a cohesive document comprising:
accessing a communication system having a plurality of social media message units accessible;
collecting a plurality of related social media message units among users over a predetermined period of time; and
outputting to a single file the plurality of related social media message units when the file reaches a predetermined size to construct a cohesive document.

18. The method for constructing a cohesive document as recited in claim 17 comprising outputting to a single file a plurality of related social media message units after a maximum predetermined period of time to construct a different cohesive document.

19. The method for constructing a cohesive document as recited in claim 17 wherein the cohesive document is constructed from related short media message units based on specific attributes such as one of users, location, and specific words.

20. The method for constructing a cohesive document as recited in claim 17 wherein a multi-phased windowing approach is used when collecting the plurality of related social media message units to handle processing based on attribute short media message units distribution.
